(19) United States
(12) Patent Application Publication
(10) Pub. No.: US 2026/0289457 A1
(43) Pub. Date: Sep. 24, 2026

(54) INTELLIGENT CLEARINGHOUSE

(71) Applicant: www.TrustScience.com Inc., Edmonton (CA)

(72) Inventors: Evan V. Chrapko, Edmonton (CA); Chris Matichuk, Aledo, TX (US); Colin Tran, Edmonton (CA)

(21) Appl. No.: 19/082,300

(22) Filed: Mar. 18, 2025

(51) Int. Cl. G06Q 10/0633

(52) U.S. Cl. CPC G06Q 10/0633

(57) ABSTRACT

Systems and methods are provided for an intelligent clearinghouse process wherein decisioning rules for responding to requests by a plurality of computerized service providers may be obtained, a set of computer system connection information may be obtained from the computerized service providers, and the sets of rules and connection information may be employed in a system that receives a relevant inquiry from an individual. Upon receipt of an inquiry including a request for decisioning and a data set, the system obtains a second relevant data set and applies a trained machine learning algorithm to the two data sets, request, and decisioning rules to reach an inquiry response. The response is transmitted to the requesting entity. The response may be transmitted to one or more computerized service providers and the computer system connection information is used to implement a networked connection between the inquiring entity and a computerized service provider.

### TECHNICAL FIELD

This invention relates generally to the use of machine learning algorithms in optimizing connections with computerized service providers based on decisioning inquiries incorporating a data set that permits identification of a second data set.

### BACKGROUND

In common decisioning processes implemented via networked computers, it is often necessary to iteratively work through a number of computerized service providers upon receiving a request for services rather than allowing for a more-optimized flow of decision-making that would enhance the decision-making process for all involved entities.

In one example of such systems, a user seeking to store computerized data within a service providers computer system may be required to iteratively and manually search for numerous service providers and compare their storage capacities, rates, availability, and other parameters such as data transfer rates or accessibility before being able to reach a decision as to which service provider is best positioned. Doing so may take up significant resources and time.

In another example, an entity seeking to ship a given or variable amount of goods across the country or overseas may seek to identify a service provider for such shipment. The ultimate amount to be shipped and destination may be a function of various other factors. For example, if shipping raw materials to a manufacturer, a combination of manufacturing costs, shipping costs, tariffs, and capacities may determine to where and the quantity of raw materials to be shipped. Known systems may require an iterative approach in which an entity is required to continually search within a system while varying parameters frequently change within the system. Such a process may be time and labor intensive.

In yet another example, an entity planning a company retreat may need to determine an appropriate destination based upon tickets that are available to various events at the destination, including both flight costs and availability, as well as availability of tickets to various types of events that different members of a company may prefer. Where employees have given ranked choices of desired events to attend, it may be necessary to attempt to optimize within the ranked choice system based upon availability, lesser ranked choices, alternative choices, pricing, and other criteria such as time, location, and a desire to have at least a minimum threshold number of employees attend a given event. Human planners may attempt to reach a response to an inquiry of this type but may require significant amounts of time and resources while still reaching a less optimal or flawed solution.

In another example, a person seeking to undertake a computerized financial transaction may desire an optimized connection to the computer systems (which may include an API) of an appropriate entity who might enable the transaction. Known systems may require an iterative process in which the person seeking to undertake the transaction may need to manually consider different service providers without knowing the full set of providers or being able to determine a solution that is preferable to a solution that might initially be presented. Even if such a person may identify potentially appropriate service providers, it may require submission of multiple credit scores to such providers to determine compatibility, where in each attempt to verify the credit score results in a reduction of the credit score, causing unnecessary harm to the person seeking to undertake the transaction.

In such processes, including the processes listed above, a long and complicated workflow, using various computing devices and steps and various types of data, may be undertaken in an attempt to ultimately match service providers with inquiring entities to meet the potentially unique requirements of an inquiring entity with respect to a service provider.

For example, in the loan industry, lenders are highly variable and potentially unique in their specific implementation of moving from a lead to issuing a loan, the “lead-to-loan” cycle. Many significant inefficiencies that are both internal and external exist in the lead-to-loan processes. These inefficiencies may include various numbers of handoffs between various stages of the processes that are directed to different departments or personnel. Such departments may include marketing, sales, business development, risk, legal, and loan fulfillment. Depending upon the systems and methods that are employed, the inquiring entity may be involved to a greater or lesser extent. Mixed results in the process of reaching a successful agreement between a lender and a borrower may stem from such involvement.

In this example, focusing on the lending business, service providers who provide leads to lenders form an entire industry unto itself. Lenders who want to outsource the hunt for leads or augment their own marketing can seek sources of potential loan applicants from third party lead providers. These lead providers may conduct their own businesses differently, using their own combination of technologies, philosophies, and tools for identifying potential leads. The lenders may have little or no visibility into the unseen processes involved in obtaining the leads, matching the leads to a lender, and selling/handing off the leads to the lender in real time based upon receiving a computerized inquiry that has a relatively short lifespan before the inquiring entity moves to another inquiry of another provider.

In some prior art systems, entities providing leads between service providers and enquiring entities may implement a process that is often referenced as a “ping tree” wherein an inquiry is first considered by service providers who can provide more benefits to the lead provider and then, after rejection by such service providers or after incompatibility with the decisioning tree of such service providers, the inquiry may be routed to service providers who provide lower benefits to the lead provider. As the inquiry traverses through such a ping tree over time, its value decreases. The time period over which such value decreases may be as low as a few seconds, may be 30 seconds, or may be longer in certain instances. The decrease in value stems both from an increasing possibility that the inquiry will be directed to another lead provider and from the common occurrence that the best leads that match the decisioning rules most closely are routed to the first service providers such that leads routed to service providers further down the ping tree are inherently less valuable.

In circumstances where a lead loses value over time, some lead providers utilize a bidding process wherein a lead is made available to all service providers at the same time. Within a predetermined timeframe, for example 30 seconds, any interested service providers must respond with a decision indicating whether the lead meets their decisioning rules and an offer related to providing the requested services. The lead provider may then select the best offer and route the lead to that service provider. In some in some such systems, the lead provider they depart from the individual decision that would result in the most benefit with respect to a single inquiry by including within the computing system a balancing algorithm to ensure a distribution of leads to various service providers.

In view of such inefficiencies, it is desirable to implement an intelligent clearing house that may automate and add efficiency to such processes.

It is further desirable to implement an intelligent clearing house that may reduce the number of human, monetary, and/or time resources in seeking such solutions.

It is further desirable to implement an intelligent clearing house that may reach an enhanced decision within a much shorter time frame than could be reached by human consideration of the problems posed.

The above-described deficiencies are merely intended to provide an overview of some of the problems of conventional systems and methods, and are not intended to be exhaustive. Other problems with conventional systems and corresponding benefits of the various non-limiting embodiments described herein may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its purpose is to set out certain aspects of the present invention and present some concepts of the specification in a simplified form as a prelude to the more detailed description that is presented later. The embodiments set forth below are intended to be non-limiting except where such embodiments describe the only manners of achieving the inventive systems and methods.

It is an objective of the inventive systems, methods, and non-transitory computer readable media to present uses for an intelligent clearinghouse. In some non-limiting aspects of the present invention, it may be desirable to obtain decisioning rules for responding to requests for decisions. Such rules may be obtained from a plurality of service providers (and may be obtained in different contexts from different sets of providers in differing fields). Each service provider may have its own rules; overlap in the rules is possible and sometimes present, but not a requirement. Different fields of service will often implicate different types of decisioning rules.

It may also be desirable to obtain, from such service providers, their system connection information for use in connecting in an automated manner to their computer systems. Some systems may be secured while others may be open. Levels of security may vary. Connection protocols may vary and may be standardized, non-standard, proprietary, publicly available or may vary in other manners. Such connection information should be sufficient to permit an automated connection to the service provider's computer systems when the inquiry is such that the inventive system or method leads to seeking a connection to such computer systems.

It is expected that the requests for decisions or inquiries are most likely to be received from computing devices of individuals seeking connection to a desirable service provider through automated means. But it is possible within the scope of the instant invention that requests or inquiries may be received from another type of entity such as a company or automated system in sequence or in bulk, such that many different connections may result from the inquiries. For example, a series of inquiries may seek a computer system for rapid transmission of data to a satellite. In such a hypothetical, it may be desirable to connect to and route several inquiries to a single service provider but as that provider receives more inquiries, it may reach a restriction criterion (or several restriction criteria) that limit the amount of available resources such that follow-on inquiries may be more desirably routed to a different service provider or group of providers at least until the controlling restriction criterion is removed, at which time it may be desirable to again route inquiries to the original single service provider.

It is expected that it may be preferable to store the obtained decisioning rules and system connection information to avoid the need to repetitively obtain such information as numerous inquiries are received and processed. But it may also be desirable to have a way for the system to check for new decisioning rules and connection information either periodically or based on some other criteria. It may, for example, be desirable to make a daily check for updates to the decisioning rules and/or connection information. Doing so may be accomplished by obtaining anew the whole set of such rules and information. Alternatively, it may be possible to check for a flag or other indication of a change in either rules or connection information and respond by obtaining the rules or information when the flag indicates a change. It may also be desirable to implement a process whereby all (or a subset of) service providers'rules and/or connection information is checked after an update to any one set of rules or connection information. Or it may be desirable to trigger the check of all information after a certain number of service providers have changed their information. Certain events may trigger the need to check for decisioning or connection changes. For example, the arrival of several large cruise ships to a port may trigger the need to obtain updated decisioning rules or connection information for providers of computer systems related to customs and immigration, while the start of a World Cup soccer match may trigger the need to obtain updated decisioning rules or connection information for providers of computer systems related to providing score updates, managing wagering, routing public transit near a stadium, or many other systems.

It will be desirable to store the received or obtained rules and connection information such that repeated retrieval is not required. Such storage may take the form of a database or a plurality of databases or other suitable storage means in which the relevant data may be retained either together or separately. It may be desirable or necessary to store certain rules and or certain connection information securely. Such secure storage may necessitate encryption, password protection, or other methods of restricting access to only authorized persons. For example, connection information may be secured until the system determines that a connection is desirable, after which the connection information may be accessed.

It is desirable to provide for a system in which an inquiry may be received from an individual, another entity, or a computer device of such individual or entity. It is preferable to receive a request for decision within the inquiry and a set of data that is relevant to the type of inquiry being posed. For example, the request for decision may include broad set of types of requests, including but not limited to, requests to connect to a more efficient computing network, requests to direct a loan request to a suitable lender, requests to route a clothing purchase to a seller that meets a certain set of criteria, requests to that meets a certain set of criteria, requests to purchase a certain type of ticket, requests to obtain public or private transportation from a certain point, requests for quotes related to the receipt of certain business services, and numerous other types of requests. Any type of request may require a specific set of data, and it is possible that even within a particular type of request, various service providers will have decisioning rules that require different types of data. Thus, it is expected that the set of data sent with the inquiry will either correspond in part to the request or allow retrieval of additional data that may be required for the determination of an appropriate service provider or set of service providers based upon the varying decisioning rules. For example, the initial data set sent with the inquiry may include a name, identification number, and birth date, which may be sufficient to retrieve various data from various types of databases for various types of requests. For example, a request for a service provider for a passport may be able to rely heavily upon such data or a request for a service provider for financial services may be able to rely heavily on such data, but a request for a service provider for efficient routing of data to a data center may not be adequately enabled through such data or the additional data for which it allows retrieval. Similarly, the request to find a service provider for purchase of particular goods at particular price with particular shipping requirements, may not be enabled by data that can be retrieved solely through name, identification number, and birth date. Such requests might require alternative types of data. In some embodiments, it may be desirable to use the data set received with the inquiry and/or various additional data related to the inquiry to respond to one or more unasked inquiries, for example, by noting properties of the data and providing additional unrequested offers of service to an entity making the inquiry.

Upon receipt of the data set with the inquiry, a request may be made to another data store, which itself may be comprised of a single database or multiple databases, and which may be located on a remote server or cluster of servers. This request is preferably accompanied by a portion of the first data set received with the inquiry, including for example the identity of the entity making the request. The second data set may be a richer set of data related to the requesting entity. For passport purposes, it might be a data set of past identification documents that include numerous types of identifying information, pictures, and other data. For lending purposes, the second data set might be credit bureau data, banking data, or other types of financial data retrieved from one or a plurality of data stores. For shipping and purchasing queries, the data might be retrieved from a collection of past purchases of goods or services by the requesting entity. For data routing inquiries, the data might include logs of past usage and the manner in which data was transmitted. As can be seen from the above examples, numerous different types of data sets may fall within the scope of the invention, depending upon the type of inquiry being made and the type of service provider that is relevant.

It is anticipated that a trained machine learning algorithm will be employed with the instant invention, and that the training data set and training parameters will be relevant to the specific type of inquiry and types of service providers for which the inventive system and method are being deployed. The inputs to the machine learning algorithm for purposes of a given inquiry may include the first data set that is received with the inquiry, the second data set that is retrieved in response to the inquiry, and the request for a decision. The machine learning algorithm will preferably consider this data in the context of the various decisioning rules for various service providers. It is desirable that the machine learning algorithm will determine a preferred, and possibly optimal, response to the inquiry by, for example, identifying an appropriate service provider based upon the inquiry, the first data set, the second data set, the decisioning rules, and preferably past decisions regarding service providers. It is anticipated that in the use of the inventive system and method, a series of inquiries that have relatively similar parameters and data associated with the inquiries, that it might seem desirable to route all of the inquiries to a single service provider based upon the decisioning rules provided by the plurality of service providers. However, it may be less apparent that it is necessary to route subsequent inquiries to a different service provider or set of service providers, based upon potential consequences of not routing inquiries to such service providers. Such consequences might include the service provider withdrawing from participation in the inventive system in method, lack of resources or full expenditure of resources of a given service provider, or overwhelming a given service provider with inquiries, leading to a degradation of the services that can be provided which may not be reflected in the decisioning rules completely. The machine learning algorithm may be trained to seek various reward scenarios to accommodate the above issues. The preferred output of the machine learning algorithm will include at least one or more responses to the inquiry that indicate an appropriate service provider, or a response indicating that zero service providers in the current set of service providers are appropriate based upon the parameters considered by the machine learning algorithm.

Upon the machine learning algorithm outputting at least one response to the inquiry, it is desirable to transmit via computer network, to the entity making the inquiry, an indication of the response output by the machine learning algorithm. For example, the indication might indicate that zero service providers were appropriate based upon the parameters. In the alternative, the indication of the output might indicate that one or more service providers were deemed appropriate. The indication might include an indication that a connection was made to the service provider's computer system on behalf of the entity making the inquiry. And the alternative it may be desirable to provide computer connection information for the one or more output service providers to the inquiring entity along with the indication of the output; And such instances, the entity may be enabled to make a direct connection to the service providers computer system from a device controlled by the entity making the inquiry. As another alternative, within the scope of the inventive systems and methods, and may be desirable for an intermediary system to make a connection to the service providers computer system automatically, using the connection information, and transmitting relevant and or necessary information to the service providers computer system. And in circumstances where desired resources of the service provider have a finite limit that may be reached, such a direct connection to the service provider's computer system may be used to reserve resources and to ensure that resources are not depleted prior to servicing the request of the inquiring entity. In such situations, it may also be desirable to update the decisioning rules or the information provided to the machine learning algorithm or both, to reflect that a portion of the service provider's resources are allocated to the entity making the inquiry.

In some embodiments, it will be desirable to facilitate either a direct connection between the inquiring entities computer system and the service providers computer system, or to facilitate an indirect connection between such systems. The exact implementation will depend upon the type of inquiry being made and the type of service provider, and may also depend upon availability of resources, security protocols, or other parameters relevant to the inquiry and the service being provided. In some embodiments, it is expected that it will be desirable to inform the service provider's computer system with an indication of the decision reached by the machine learning algorithm, so that the service provider's system can allocate appropriate resources to the inquiry, or can contact the inquiring entity, or can take other appropriate action. Where the output of the machine learning algorithm indicates that a plurality of service providers are desirable with respect to the inquiry, it may be desirable to choose only one such service provider for a connection with the inquiring entity, or it may be desirable to provide connection information for multiple service providers, or and it may be desirable to provide a choice of service provider to the inquiring entity. The circumstances of the specific type of inquiry may dictate which such response is most desirable.

Numerous types of inquiries following within the scope of the inventive system and method will be time sensitive inquiries that require processing of large amounts of data within time frames that are impossible to meet through processing with the human mind. In some instances, responses to inquiries will be required within fractions of seconds, and others within seconds, and others within tens of seconds, and in others within minutes. It is possible that some inquiries may allow for a response time of hours which may still lead to a decision much faster than would be capable using the human mind, based upon the sheer magnitude of the data being processed in conjunction with the decisioning rules of a plurality of service providers. Certain types of inquiries must be processed within a period of 5 minutes or less before the inquiring entity loses interest in the response to the inquiry. Other types of inquiries which might be used in conjunction with serving websites to viewers, might require a response within fractions of seconds or seconds to ensure that the inquiring entity does not lose interest in the inquiry before the inquiry can be processed and a response gathered. The parameters of the machine learning algorithm may be modified within the scope of the inventive system and method to ensure that a best possible response within a given time period is obtained, even though a longer period may be needed to obtain a better response or an optimal response.

In certain embodiments it may be desirable to receive more than one response to the inquiry from the machine learning algorithm. In such embodiments, the algorithm may be prompted to output additional responses based upon the inquiry, the data sets, and the decisioning rules. It may be desirable to obtain one additional response, or it may be desirable to obtain a plurality of additional responses. In the event that one or more additional responses is received from the algorithm, some embodiments will send an indication of the additional responses to the computing device of the inquiring entity. In many instances it will be desirable to send such responses within 10 seconds of the transmission of the initial response. Search constraints may be in place where a human is operating the computing device that sends the inquiry, because the human attention span for certain types of responses may be limited to approximately 10 seconds. The additional responses, similar to the initial response, are preferably sent via a computer network from the computing device on which the machine learning algorithm is executing to the computing device that posed the inquiry. And the alternative, in certain systems it may be desirable to send the responses to an alternative computing device that is not the one that posed to the inquiry; such devices may include the computer systems of the service providers. In some instances and/or countries, it may be necessary or preferable to obtain consent from the entity making the inquiry and that such consent be obtained before data related to the inquiry is sent to a service provider. Thus, in such circumstances, it may be desirable to publish a list of potential service providers to the entity making the inquiry so that consent may be obtained before providing the entity's data to a service provider. Such circumstances might provide instances in which the language seeking consent is dynamically determined based on the combination of potential service providers, the parameters of the entity making the inquiry, and/or other relevant parameters being met or not being met. Alternative instances and/or countries may exist in which consent is not requested nor obtained from the entity as to one or more service providers, but it may become desirable to send a portion of the entity's information to the one or more service providers to pre-screen the entity's information or alternative apply decisioning rules of the one or more service providers to the entity's information to determine whether a more complete set of the entity's information should be sent to the service provider's computer system. In such circumstances, it may be desirable to seek consent a second time, after applying the decisioning rules or sending the initial portion of the entity's information.

In many embodiments, the inquiry may preferably include one or more criterion that indicate the compatibility of the request to the decisioning rules of the one or more service providers. If the service providers are not compatible with the request, then the request compatibility criterion may provide an early indication that some or all of the pool of potential service providers should be eliminated. A request may also include a desired amount of available resources. The available resources may include processor cycles, computer data storage parameters, or other types of resources depending upon the type of inquiry. In some instances, it may be desirable to determine whether an appropriate number of tickets remain available for a ticketed event, whether appropriate number of seats remain available upon public transportation, whether appropriate amounts of funds to borrow remain available, or whether any given resource that is the subject of an inquiry using the inventor system and method is available in sufficient amounts.

In certain embodiments, it is anticipated that one or more of the service providers will include decisioning rules that have varying levels of complexity. Some such rules may include constraints upon responses to a particular inquiry. For example, if the inquiry relates to the use of storage space in the shipping environment, a freight company that provides delivery by truck may include a maximum number of cubic feet available with respect to an inquiry, whereas a freight company that provides delivery by container ship may include a minimum number of containers that must be committed if the inquiry is successful. If the inquiry relates to a loan, some service providers may set a maximum or minimum amount of funds that can be committed to a single inquiry. It is also anticipated that the decisioning rules for any particular service provider may include one or more constraints upon the amount of resources that are available to be committed within a restriction criterion. Restriction criterion may be a time period, such as a day, an hour, a minute, a month, a year, a decade, or another time period. A restriction criterion may be a number of railcars, ships, trucks, or other shipping vehicles. A restriction criterion may relate to a number of performances, a quantity of hotels, a geographic criterion, an age criterion, or any number of criteria that are themselves relevant to the service provider with respect to making a decision upon an inquiry. In one example, the decisioning rules may provide that only a certain number of dollars may be committed to loans within a single month period. in another example, the decisioning rules may provide that only a certain number of loans may be made within a specific city or time zone. In yet another example, the decisioning rules may provide that only a certain number of seats at a concert may be purchased by an individual. And yet another example, the decisioning rules may provide that only a certain percentage of overall bandwidth may be committed to an individual inquiry within a 5-minute window. Numerous variations of such restriction criterion may exist and may fall within the scope of the inventive system and method. It is anticipated that a plurality of such criteria may be combined within the decisioning rules of any service provider within the pool of service providers.

To the foregoing and related ends, systems, devices, and methods are disclosed that can facilitate implementation of machine learning algorithms and communication processes to obtain enhanced results when compared to prior systems.

In addition, further exemplary implementations are directed to other exemplary methods, and associated systems, devices and/or other articles of manufacture that facilitate an intelligent clearinghouse, as further detailed herein.

These and other features of the disclosed subject matter are described in more detail below.

### BRIEF DESCRIPTION OF THE DRAWINGS

The devices, components, systems, and methods of the disclosed subject matter are further described with reference to the accompanying drawings in which:

FIG. 1 is an illustrative process for an intelligent clearinghouse according to the current invention(s);

FIG. 2 is an illustrative process for an intelligent clearinghouse according to the current invention(s);

FIG. 3 is an illustrative process for an intelligent clearinghouse according to the current invention(s);

FIG. 4 is an illustrative process for an intelligent clearinghouse according to the current invention(s);

FIG. 5 is an illustrative process for an intelligent clearinghouse according to the current invention(s);

FIG. 6 is an illustrative process for an intelligent clearinghouse according to the current invention(s);

FIG. 7 is a block diagram of an illustrative architecture of a computer that may be used in a system or method for an intelligent clearinghouse; and

FIG. 8 is a block diagram of an illustrative architecture for an intelligent clearinghouse according to an embodiment of the invention.

### DETAILED DESCRIPTION OF ILLUSTRATIVE EMBODIMENTS

As described above, conventional processes for handling user information and/or solutions for misuse or potential misuse provide some measure of security, user control, and/or rectification for data breaches, such efforts fail to provide meaningful solutions for increased user control and/or security of user information, and/or are subject to further costs or drawbacks, etc., among other deficiencies.

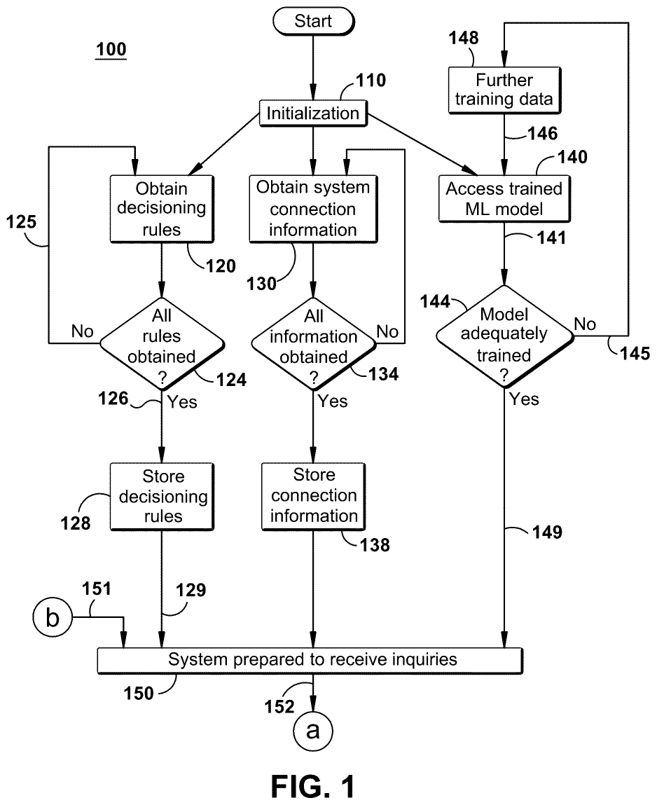

FIGS. 1-6 represent an illustrative flow chart of various embodiments of the invention, including certain alternative embodiments.

Referring now to FIG. 1, a flow chart 100 is illustrated. The process illustrated in FIG. 1 proceeds from the starting node to an initialization step 110. In step 110, three separate processes are initialized, a process to obtain decisioning rules 120, a process to obtain system connection information 130, and a process to obtain access to a trained machine learning model 140.

Referring first to the rules obtaining process 120, a request is sent to at least one service provider (and potentially multiple service providers) for the service provider's decisioning rules with respect to inquiries that are received and that seek possible engagement of their services. The service provider(s) may return the decisioning rules if the service provider wishes to participate in the inventive system or method. The process proceeds to decision step 124 at which an inquiry as to whether all decisioning rules for participating service providers have been obtained. If the answer to that inquiry is negative, the process will return to step 120 as indicated by path 125. If the answer to the inquiry of Step 124 is affirmative, the process will proceed to step 128 via path 126. After the decisioning rules have been obtained from the service providers, at step 128, the decisioning rules may be stored. The storage may be in a database, a data center, or in another acceptable system or manner of storing decisioning rules. For example, it may be desirable to store the decisioning rules in a blockchain or using a distributed file system, either in a publicly available form or in an encrypted form. Storing the rules in a publicly available form allows further queries against the rules by any person that has access to the storage mechanism. The rules may be stored in portions as they are received, in sequence, in batches, or using another suitable method for storing decisioning rules. It is not necessary that all decisioning rules be obtained before storage step 128 is processed with respect to the earlier obtained rules. After the decisioning rules are stored, the process proceeds along path 129 to step 150.

Referring now to step 130, the inventive system and method obtains system connection information from various service providers in step 130. Such connection information may include passwords, keys, access information, protocols, API information, or other information that may be necessary or desirable for the inventive system and method to allow connections to the service provider's computerized systems when a match between an inquiring entity and the service provider is made by the machine learning model. When at least one set of system connection information is received, it is desirable for the process to proceed to an inquiry in step 134 wherein the system queries whether all the relevant system connection information has been obtained from the relevant service provider(s). If the answer to that question is negative, it is desirable to proceed back to step 130 wherein further system connection information may be obtained by requesting such information from the relevant service providers whose system connection information is still needed. If the answer to the inquiry in Step 134 is affirmative, then the process may proceed to step 138, where the system connection information is stored. As discussed with respect to step 128, in step 138, it is also possible to store the information periodically or serially, rather than waiting to obtain all the information before initializing the storage. Similar to the storage mechanism used in step 128, the information obtained through steps 130 and 134 may be stored in a variety of storage mechanisms that are appropriate based upon the processes being employed and the level of security or public availability that is desired. After the connection information is stored in step 138, the process may proceed to step 150.

Referring now to step 140, the inventive systems will preferably obtain access to a trained machine learning model to ensure that the model is available for processing inquiries when such inquiries are received. The process may proceed along path 141 to step 144 at which point an inquiry is made to determine whether the model is adequately trained. This inquiry in step 144 may be made by providing test data to the machine learning model to obtain an expected output, or it may be a quantitative or qualitative inquiry related to the amount or type of training data with which the model has been trained. Depending on the specific types of inquiries and service providers implicated by an embodiment, certain standards or requirements may be in place with respect to the parameters for training the machine learning model. Certain service providers may require that the model has been trained using particular data sets, particular qualities of data, particular quantities of data, or other types of requirements to meet the specifications for such service providers. It is anticipated that, at times, a conflict between service providers may exist wherein the training requirements cannot be matched. However, it is anticipated that in many instances, it will be desirable to provide additional training data such that the service providers'training requirements may be considered cumulative rather than exclusive. In step 144, if the inquiry reveals that the model is not adequately trained, the process may proceed along path 145 to step 148. In step 148, further training data may be provided to the model to allow the model to be trained upon such data. The process may proceed along Path 146 to step 140, wherein the inventive systems and methods may determine whether the model has completed the training and may be accessible. In some instances, it may be desirable to begin use of the model even while it is being trained with training data. But it is anticipated that in many instances the model will be trained on the training data before the processing of inquiries begins. In step 144, if the model has been adequately trained, the process may proceed along path 149 to step 150. At step 150, after indications from each of the three parallel paths related to obtaining decisioning rules, obtaining system connection information, and accessing the trained model, have been received, the system will be prepared to receive inquiries. When the system is prepared to receive inquiries in step 150, the process may proceed via path 152 to node a.

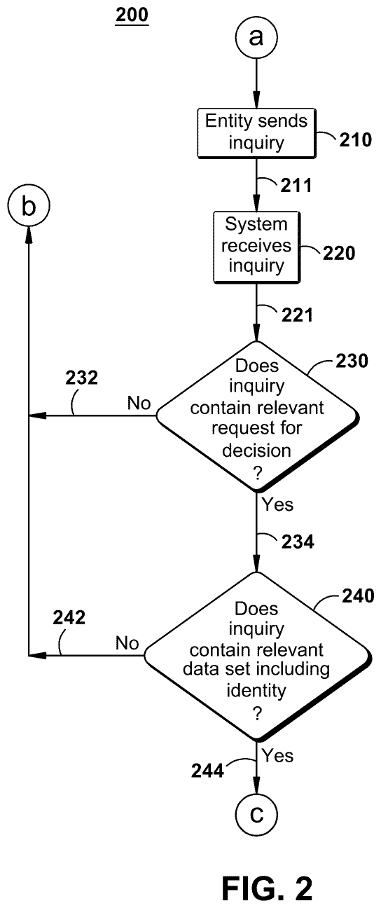

In the figures herein, node a is used to denote a connection between alternative or incomplete flow charts depicted in different FIGs within this disclosure. As indicated on FIG. 1, path 151 emerging from node b may direct the process to step 150 wherein the system is prepared to receive inquiries. Similar to node a, node b in this FIG, and other FIGs, is used to denote connections between various FIGs. Similar to nodes a and b, in FIGS. 2-6 reference is made to nodes c and d, which are also intended to denote connections between varying FIGs in this disclosure.

Referring now to FIG. 2, which shows a flow chart 200 depicting a portion of an embodiment of the inventive system and process, the process proceeds from node a to step 210. In step 210, an inquiring entity sends an inquiry to the system for processing. The process proceeds along path 211 to step 220. In step 220, the system receives the inquiry and begins processing the inquiry.

As noted in the other disclosures herein, such inquiries may include a variety of inquiry types. Such inquiries may include, for example, requests for bandwidth in a system, requests for storage space, requests for processing operations, requests for ticketing, requests for planning of events, requests for. matching lenders and persons seeking loans, and numerous other types of requests. In step 220, the inventive system receives the inquiry from the inquiring entity. The process proceeds along path 221 to an inquiry at step 230. In step 230, the system queries whether the inquiry contains a relevant request for decision. Depending upon a subset of parameters provided by service providers (or derived from decisioning rules) or upon a more complex set of criteria, this determination may take various forms. If the inquiry does not contain a relevant request for decision, the process may proceed along path 232 to node b wherein the process may return along path 151 to step 150 (as indicated in FIG. 1). At that point, the system may continue to wait for receipt of the relevant inquiry before further processing. (In the inventive systems, several inquiries may be processed in parallel, such that the system may be simultaneously waiting at step 150 while processing other inquiries in parallel threads.) In the alternative, if step 230 determines that the inquiry does contain a relevant request for a decision, the process may proceed along path 234 to step 240.

At step 240, a secondary inquiry may be made into whether the inquiry received in step 220 contained a relevant data set, including the identity of the entity making the inquiry. In some contexts, identification of the entity may take varying forms and may require varying levels of detail. For example, in some processes the identity may be as simple as an IP address, a MAC address, or another type of computer address indicating the computer from which the inquiry was received. In other processes, the identifying information may include a tax identification number or another form of identification number such as a driver's license number or a Social Security number. In other types of inquiries, the identification may include an account number, an address, or other forms of identification. In some inquiries, the required identification information may be required to include information such as name, birth date, Social Security number, address, and/or additional information. The parameters of such requirements may be set by the system operator or maybe set by service providers in some instances. It may also be desirable to derive such requirements from the decisioning rules by using a machine learning algorithm trained for such purposes. Service providers may require varying amounts or types of identification information. In such circumstances, it may be preferable to proceed with the inquiry if the received identification information meets the requirements of at least one of the service providers. For example, if one service provider requires only an address, while another service provider requires a company name, an address, and a telephone number for identification, it may be desirable to proceed with the inquiry when only a minimal amount of identification information is received (e.g., only an address), even though that will eliminate consideration of the decisioning rules of certain service providers. It may be desirable to inform the inquiring entity that the number of service providers that can be considered will be reduced unless the inquiring entity is able and willing to provide additional identification information; such a notice may provide statistics or numerical projections and may indicate either specifically or generically the type of identification information that will increase the number of service providers that can be considered. The identification information may be inform a decisioning rule, but it may be a rule that should be handled prior to application of the more complex decisioning rules. In some instances it can be anticipated that a particular service provider may require a Social Security number and name, while another type of service provider may require a birth date and name. If an inquiring entity submits only a name, but neither Social Security number nor birth date, the provided identification information will be insufficient for either of the two service providers. But if the individual making the inquiry submits name and birth date, it will be possible to proceed with the process with respect to one of the two service providers but not the other. If the inquiry at Step 240 determines that insufficient identifying information or other data has been received with respect to all service providers, the process may return along path 242 to node b.

In some embodiments, it may be desirable to make the determination at step 240 that if even one service provider's identification information requirement is not met, then the process should proceed along path 242 back to node b. Varying parameters may be incorporated into different embodiments of the inventive system and method, or even into different operational parameters of the inventive system and method, depending upon the deployment. If a relevant data set including identification information is received at step 240, then the process may proceed along path 244 to node c. It should be recognized that the ordering of steps 230 and 240 may be switched without changing the inventive character of the disclosure herein. Similarly, inquiries 230 and 240 may be processed in parallel without changing the inventive character of the disclosure herein.

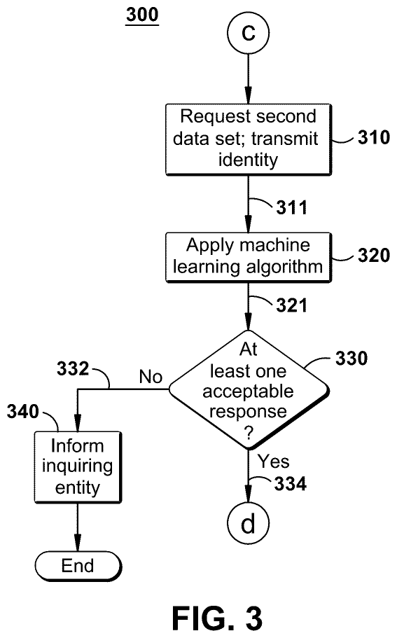

Referring now to FIG. 3, a flow chart 300 of a portion of an embodiment of the inventive system and method is depicted. The process may proceed from node c to step 310. In step 310, the identity that was received in step 220 may be transmitted to a remote system along with a request for a second data set. The identity may serve to assist with specification of the data to retrieve in the second data set. For example, if the identification information is an account number, then the request for the second data set may be related to records tied to that account number. If the identity is an IP address, the request for the second data set may be a request for data related to that IP address, such as historical transmission rates, speeds, frequency, etcetera. If the request relates to a name and Social Security number, a remote database may use that information to retrieve banking information, credit bureau ratings and details, or other relevant information that relates to a person's name and Social Security number. Many other types of second data sets may be retrieved in this step, depending upon the parameters of the inquiry made at step 210 and the service providers about whom the inquiry is being made. For example, credit rating data related to Social Security number might be retrieved. Alternatively, banking data might be retrieved. To retrieve banking data (and various other types of data), login information (such as login, password, and/or multiple factor authentication data) might be required. If such information is required, it may be preferable to collect such data with the inquiry. An alternative embodiment might provide an interface for receiving the login information at the appropriate time. And certain types of data might require consent for retrieval; in such instances, it may be preferable to provide an interface for receiving consent either prior to receiving the inquiry in step 220 or during processing of the inquiry in later steps.

Upon receipt of the second data set, the process may proceed along path 311 to step 320. At step 320, the machine learning algorithm is applied to the first data set that was received with the inquiry, the second data set that was received in step 310, and the decisioning rules of one or multiple service providers that were obtained and stored in steps 121, 124, and 128. It is preferred that the machine learning algorithm give an indication as to when it has reached at least one response so that the process may proceed. Upon such an indication or after another relevant indication (e.g., time passage, processing cycles used, receipt of another inquiry, etc.), the process proceeds along path 321 to step 330 after the machine learning algorithm of step 320 has responded. In step 320, it may be desirable to use an alternative to a machine learning algorithm or to combine a machine learning algorithm with other processes to determine acceptable responses. For example, a rules engine or other decisioning tree may be used in step 320. In at least one embodiment, it may be necessary or preferable to obtain consent from the entity making the inquiry and that such consent be obtained before data related to the inquiry is sent to a service provider. Thus, in such circumstances, it may be desirable to publish a list of potential service providers to the entity making the inquiry so that consent may be obtained before providing the entity's data to a service provider. While some systems may publish a list of all or many service providers for consent, it may be desirable to optimize (or enhance the utility of) the list of service providers provided for consent based on factors such as those discussed below with respect to steps 610 and 630. Such enhancement of the list may be based upon enhancing expected utility, complying with rules or processes of service providers or third parties, ensuring that service providers remain active with the inventive system, or other factors that are desirable to the implementer of the inventive system. The above-mentioned circumstances in which it is necessary or preferable to obtain consent might provide instances in which the language seeking consent is dynamically determined based on the combination of potential service providers, the parameters of the entity making the inquiry, and/or other relevant parameters being met or not being met. Alternative circumstances may exist in which consent is not requested nor obtained from the entity as to one or more service providers, but it may become desirable to send a portion of the entity's information to the one or more service providers to pre-screen the entity's information or alternative apply decisioning rules of the one or more service providers to the entity's information to determine whether a more complete set of the entity's information should be sent to the service provider's computer system. In such circumstances, it may be desirable to seek consent a second time, after applying the decisioning rules or sending the initial portion of the entity's information.

At step 330, an inquiry is made as to whether the machine learning algorithm has returned at least one response that would be acceptable based upon the parameters of the inquiry submitted by the inquiring entity in step 210. For example, if an acquiring entity seeks to obtain options for ticketing information at a given price point for a specified number of persons, then the machine learning algorithm may return an acceptable result or may return a result indicating that no tickets match the criteria. If the inquiry relates to availability of processing resources or data storage resources with certain pricing and access parameters within a certain time period, then it is possible that at least one acceptable service provider may be identified. Or it is possible that zero acceptable service providers may be identified based upon the decisioning rules applied by the machine learning algorithm. If the inquiry relates to the availability of a loan to purchase a car, the machine learning algorithm may indicate that at least one service provider has decisioning rules that are met by the inquiring entity. Or it is possible that the machine learning algorithm will indicate that zero service providers have decisioning rules that align with the criteria supplied by the inquiring entity. At step 330, when the inquiry is made, if a negative response is received, the process may proceed along path 332 to step 340. At step 340, the inquiring entity may be informed that none of the service providers whose decisioning rules were applied is able to provide the requested services. The process may then end upon providing such an indication to the inquiring entity.

Alternatively, the process may continue by allowing the inquiring entity to provide different or additional data and attempt the process again seeking an affirmative response. For example, an entity seeking 50 tickets to an event at a price point of $10 or less per ticket might be given the option to seek a lesser number of tickets, a higher price point, or a combination of both. An entity seeking a loan may be given an opportunity to seek a smaller loan amount, a different payback term, a different down payment, or other variance in factors that may influence how the decisioning rules are applied.

In some instances, it may be advantageous to either the service providers or the operator of the inventive system and method to provide hints to the inquiring entity about acceptable potential changes to the inquiry, based upon what was learned during the processing of the machine learning algorithm. For example, if the service providers are loan providers and each of the service providers requires a minimum loan amount of $5000, but the inquiring entity requested a loan of only $4000, the system might be configured to inform the inquiring entity that the minimum loan amount will be $5000 and allow the inquiring entity to place an inquiry regarding a loan of $5000 rather than $4000. In another hypothetical, if an inquiring entity is seeking capacity to store 10 terabytes of data with certain access speed parameters and the available service providers cannot match the requested access speed parameters, the inventive system may be configured to provide a hint by informing the requesting entity of the best, average, or other threshold related to access speed that is available through the available service providers. In such manners, it may be possible to gain the further participation of inquiring entities that might otherwise be lost to a different set of service providers.

At step 330, if the machine learning algorithm provides at least one acceptable response indicating a match between a service provider and the inquiring entity, the process may proceed along path 334 to node D.

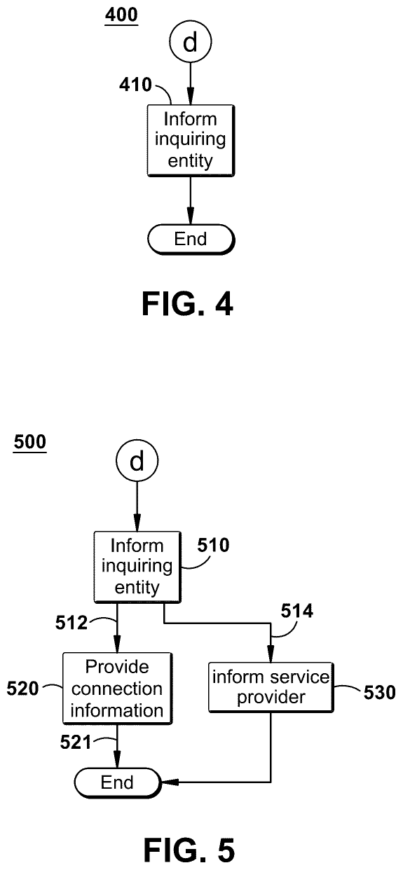

Referring to FIGS. 4 and 5, these figures provide alternative embodiments of the process occurring from node d to an end point. In the flowchart 400, FIG. 4 indicates that at step 410, the inquiring entity is informed of an acceptable match with a service provider. The process may then end in this embodiment.

In FIG. 5, flow chart 500 illustrates an alternative embodiment of the process. From node d, the process proceeds to step 510. In step 510, the inquiring entity is informed that at least one acceptable match with a service provider was indicated by the machine learning algorithm (step 320). From step 510, two separate paths emerge, paths 512 and 514.

Referring to path 512, the process proceeds to step 520 wherein the inquiring entity is provided with connection information, allowing the inquiring entity's computer system to connect to the computerized system of the service provider. In certain embodiments of the invention it is recognized that at step 520, an automatic connection may be made, either directly between the inquiring entity's computer system and the service provider's computerized system, or between the service provider's system through the inventive system to the inquiring entity's computer system. Alternatively, in some embodiments, it may be preferable to make an alternative type of connection. Such connections may include providing passwords, transaction reference numbers, or even providing access to an API or a proprietary communication protocol.

In parallel with step 520, the process may proceed from step 510 along path 514 to step 530. In step 530, the service provider may be informed that a match has been made with an inquiring entity. As part of step 530, it is also possible to provide various parameters of the match with the inquiring entity, including constraints on resources that may be necessary after the connection is made. For example, in a system where bandwidth or storage space is sought, the service provider may be informed of the quantity that is needed so that the required resources can be allocated and withheld from others seeking to use the same resources. In situations where a match is made for a loan, the service provider may be informed that a certain loan amount has been committed, such that the service provider may ensure that the appropriate financial resources have been retained and will not be inadvertently double-committed through devotion the same resources to other actions or entities. Each of steps 520 and 530, while being executed in parallel, may proceed to an endpoint after the step is completed. FIG. 4

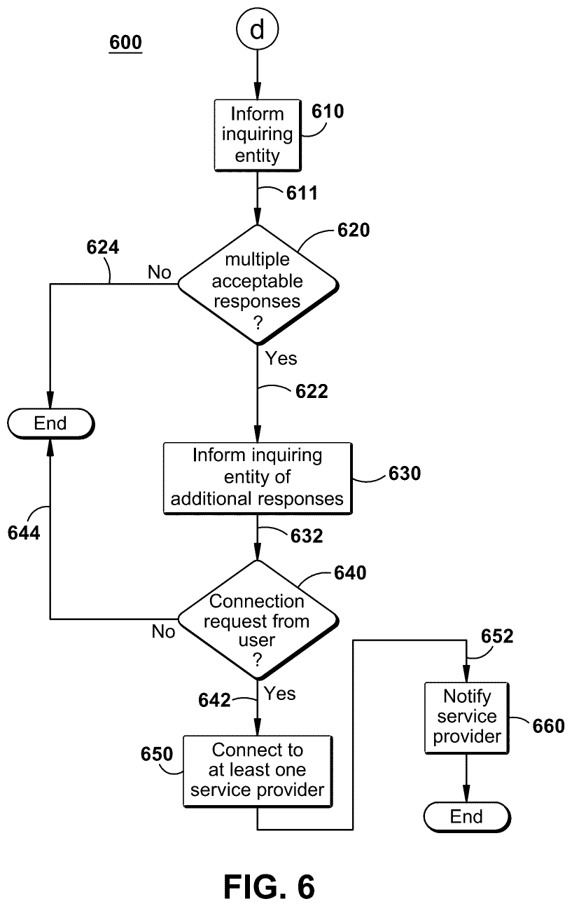

Referring now to FIG. 6, flow Chart 600 depicts an alternative portion of the inventive method starting with node d. In the alternative presented in FIG. 6, it may be desirable to inform the inquiring entity of multiple matches between the inquiring entity and service providers. Informing the inquiring entity of multiple matches may be useful where it is desirable to present varying choices to the inquiring entity. It may also be desirable in certain instances wherein various service providers'services must be combined to provide the inquiring entity with a full set of requested services. For example, if an inquiring entity seeks to borrow $2000 and each of the service providers has a maximum loan amount of $1000, it may be necessary to combine loans from two or more service providers to reach the amount requested by the inquiring entity. In the hypothetical wherein the inquiring entity seeks a large block of tickets to an event, any given service provider may have an insufficient number of tickets available, but by combining the services of various service providers, it may be possible to aggregate enough tickets to meet the request. Similarly in systems where a large quantity of processing cycles or memory for data storage is required, it may be necessary to aggregate the services of multiple service providers to meet the request of the inquiring entity.

From node d, the process may proceed to step 610 where the inquiring entity is informed of a match between a service provider and the inquiry posed by the inquiring entity. In some instances, the service provider may be able to provide sufficient service to accommodate the entire request of the inquiring entity period. However, it may be desirable to indicate the availability of multiple alternative service providers. After informing the entity of at least one service provider that is available, the process may proceed along path 611 to step 620. In step 620, an inquiry as to whether multiple acceptable responses were received from the machine learning algorithm may be posed. If the machine learning algorithm identified multiple service providers that can service the received inquiry, then the response to this inquiry of step 620 will be affirmative. If the machine learning algorithm indicated only a single service provider that was acceptable, and that service provider has already been identified to the inquiring entity, then the process may proceed along past 624 to the end. Where multiple acceptable responses were identified by the machine learning algorithm, the process may proceed along path 622 to step 630. As an alternative to informing the inquiring entity of a particular acceptable response in step 610 or further acceptable response(s) in step 630, it may be desirable to inform the inquiring entity of options that are available. Alternatively, it may be desirable to optimize the information provided to achieve higher utility by giving preference to identifying certain acceptable responses over others. Alternatively, it may be desirable to inform the inquiring entity of a particular acceptable response to maintain a contract with a service provider, to apply other governance rules related to one or more service providers, or to ensure that a service provider remains an active service provider even if other utility might be lost by providing that service provider's acceptable response to the inquiring entity. Alternatively, processes of the service provider and/or a third party connecting the inquiring entity with the inventive system might require that acceptable responses be provided in some manner that results in reduced utility.

In step 630, the system may inform the inquiring entity's computer that additional acceptable responses are available to the inquiring entity. The system may provide an indication of such responses, including by identifying service providers, by identifying terms, by making connections, or by other indication of the acceptable responses.

In the circumstance where the connection is not automatically made, the process may proceed along path 632 to step 640. In step 640, the system may determine whether the user has desires an automatic connection with one or more service providers. If the response to the sent query is negative, the process may proceed along path 644 to the end. In the circumstance where the response to the inquiry of step 640 is affirmative, the process may proceed along path 642 to step 650. In step 650, a connection is provided between the inquiring entity's computer system and the service provider's computer system by using the connection information that was retrieved in steps 130, 134, and 138. Upon making the connection to the service provider, it is often desirable to proceed along path 652 to step 660. In step 660, the service provider is notified that the connection has been made by the relevant system. It is anticipated that the service provider will often know how and why the connection was made, but in circumstances where this is not known, the notification of step 660 may be necessary. After step 660, the process may end.

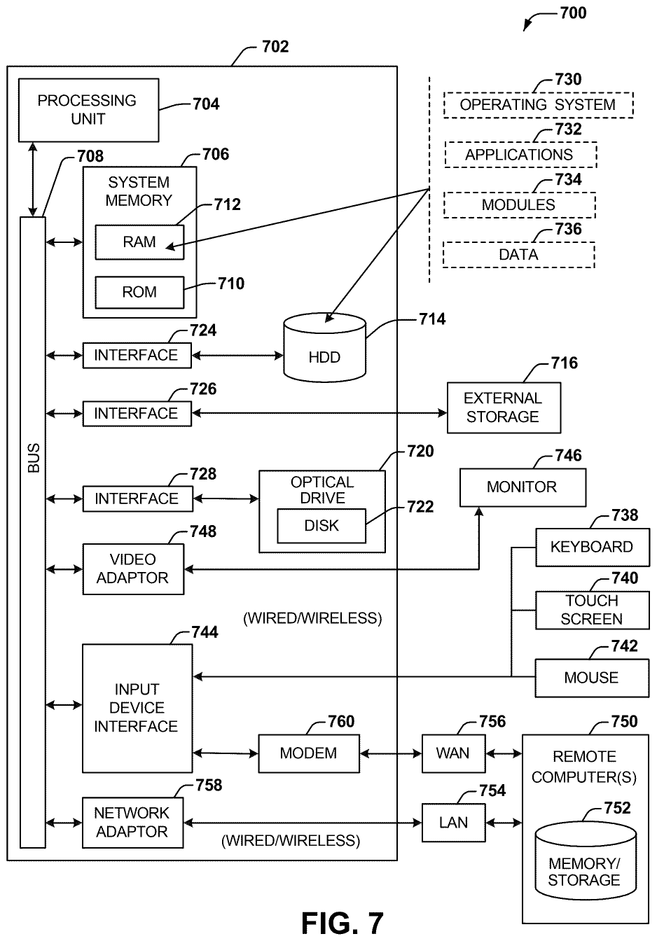

To provide additional context for various embodiments described herein, FIG. 7 and the following discussion are intended to provide a brief, general description of a suitable computing environment 700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that portions of the inventive methods can be practiced with other computer system configurations, including single-processor or multiprocessor computer systems, minicomputers, mainframe computers, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 712 can also include a high-speed RAM such as static RAM for caching data.

The computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both Universal Serial Bus (USB) and Institute of Electrical and Electronics Engineers (IEEE) 794 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the . NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

A user can preferably enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can also be connected to the system bus 708 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the Internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the Internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are examples and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

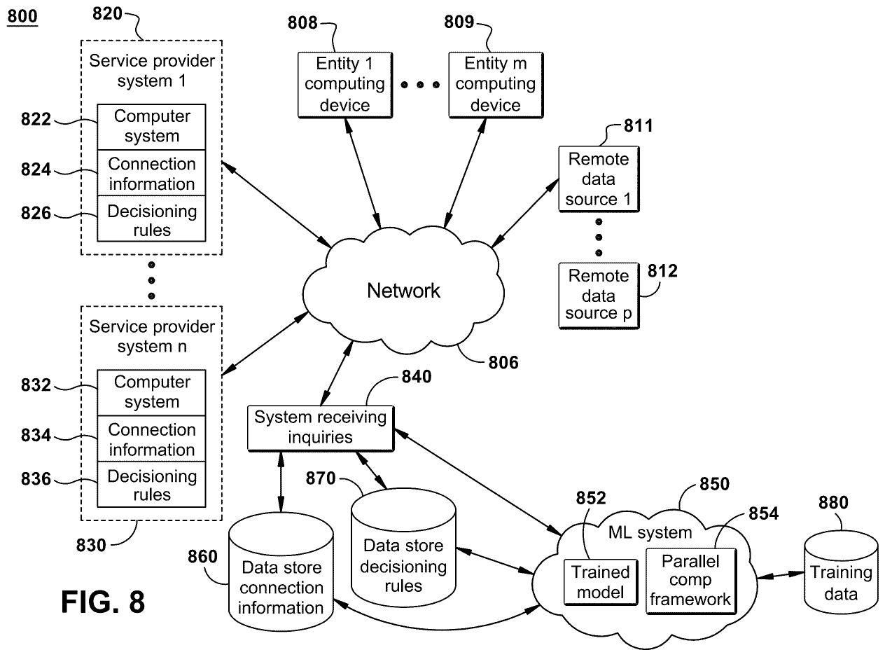

FIG. 8 depicts a functional block diagram illustrating an exemplary environment 800 suitable for use with aspects of the disclosed subject matter. For instance, it depicts an exemplary set of devices, parties or participants communicatively coupled to each other and involved in the provision, collection, use, and distribution of information related to the implementation of an intelligent clearinghouse. For example, a computing device 808 of a first entity can provide and receive information, through communication network 806, to and from other devices (illustrated and not illustrated) communicatively coupled to communication network 806. A number of such computing devices labeled 808 and 809, and denoted as multiple devices through the use of an ellipses denoting multiple devices 1 to m, may be coupled with the network 806. Each such device may be associated with a different entity; although, it is often likely that a single entity will possess multiple devices 808, 809 that are all coupled to a network 806.

A device 808, 809 may be a hardware device and may comprise a computer application. Though only two such devices 808, 809 are depicted, it is to be understood that in many networks it is possible to connect and communicate with multiple devices 808, 809. Device 808, 809 may be communicatively coupled to network 806 via wired, wireless, or combination connections. As a non-limiting example, device 808, 809 may be a mobile or stationary computer, a mobile phone, an augmented reality device, or other such hardware as may become available and allow such communication. It will be understood that references in this disclosure to computer systems of inquiring entities may be used to refer to devices such as devices 808, 809.

Remote data sources 811, 812 may also provide and receive information, through network 806, to and from other devices communicatively coupled to the network 806. A number of such data sources labeled 811 and 812, and denoted as multiple devices through the use of an ellipses denoting sources 1 to p, may be coupled with the network 806. Remote data sources 811, 812 may be part of a system that is largely or wholly controlled by an artificial intelligence (“AI”) or machine learning (“ML”) algorithm, or may be largely or wholly controlled by a human or other non-learning computer systems.

Similar to devices 808, 809, remote data sources 811, 812 may be hardware devices and may comprise a computer application. Though only two remote data sources 811, 812 are depicted, it is to be understood that in many networks it is possible to connect and communicate with multiple data sources 811, 812. Data sources 811, 812 may be communicatively coupled to network 806 via wired, wireless, or combination connections. As a non-limiting example, data sources 811, 812 may be mobile or stationary computers, mobile phones, augmented reality devices, servers in a data center, distributed computing systems, distributed file systems, block chains, or other such hardware as may become available and allow implementation of such systems with communication.

Similar to devices 808, 809, service provider systems 820 and 830 may be hardware devices and may comprise a computer application. Though only two systems 820, 830 are depicted, it is to be understood that in many networks it is possible to connect and communicate with multiple service provider systems, as indicated by the ellipses denoting multiple systems from 1 to n. Systems 820, 830 may be communicatively coupled to network 806 via wired, wireless, or combination connections. As a non-limiting example, systems 820, 830 may be mobile or stationary computers, mobile phones, augmented reality devices, servers in a data center, distributed computing systems, distributed file systems, block chains, or other such hardware as may become available and allow implementation of such systems with communication. Each service provider system 820, 830 will preferably include a computer system 822, 832, a repository of connection information 824, 834, and a repository of decisioning rules 826, 836. The components of such systems 820, 830 may be located together on a single computing device, separately on a plurality of computing devices, or even in remote locations with various devices connected via networks.

Data sources may include bank system(s), credit bureau system(s), billing system(s), activity tracking system(s), etc. and may be implemented through one or more of the other devices and/or systems illustrated as system 700. Bank system(s) and credit bureau system(s) may have their own complex security and interface systems, a discussion of which is beyond the scope of this disclosure. Thus, such systems may be treated as interacting in largely the same manner as the other components for purposes of the discussion herein, while keeping in mind that such systems will likely have complex security and interface issues.

A system receiving inquiries 840 may comprise a suitable computer server which may include a web server, file server, or other server along with appropriate control mechanisms. System 840 may be configured to receive data including inquiries from device(s) 808, 809 and/or data from sources 811, 812. Such inquiries and data may be conveyed via network 806.

Connection information data store 860 and/or decisioning rules data store 870 may be separate or combined and may each be connected communicatively to system 840, network 806, and/or service provider systems 820, 830. Training data store 880 is preferably communicatively coupled to at least machine learning system 850.

Machine learning system 850 may be implemented using various frameworks. Preferably a parallel computational/processing framework 854 is employed. As illustrated, a single parallel processing framework or components thereof may be used to implement system 850. Within the scope of certain embodiments of the invention, it may be desirable to apply a trained machine learning model 852 to data as described with respect to FIG. 1-6 and the other disclosure herein. It may also be desirable to communicate through system 840 and network 806 to obtain data directly from sources 811, 812 and/or systems 820, 830. Such a model 852 is preferably used to consider inquiries regarding service providers based on the inquiry, the decisioning rules, and the relevant data.

Communication network 806 may include wired and/or wireless network components, such as the Internet, cellular, or local area wireless networks. Communication network 806 may also include networks such as Bluetooth and infrared networks. Communications on communications network 806 may be encrypted or otherwise secured using any suitable security or encryption protocol.

System 840, which may include any network server or virtual server, such as a file or web server, may access data sources 1 . . . p 811, 812 locally or over a suitable network connection such as network 806. Systems 820, 830, 840 may also include processing circuitry (e.g., one or more computer processors or microprocessors), memory (e.g., RAM, ROM, and/or hybrid types of memory), and one or more storage devices (e.g., hard drives, optical drives, flash drives, etc.). The processing circuitry included in systems 820, 830, 840 may execute processors capable of executing various processes in parallel. System 840 may be able to receive, process, and distribute information generated by an application executing on a device 808, 809, such as a computer or a mobile device (e.g., a cell phone, a wearable mobile device such as an augmented reality device, etc.). The processing circuitry included in system 840 may also perform a host of calculations and computations that may be needed in managing and determining continuous identity. In some embodiments, a computer-readable medium with computer program logic recorded thereon is included within system 840. The computer program logic may perform various of the steps described herein with respect to identity determination. In some embodiments, system 840 and system 850 may be combined in a single computing device with sufficient processing capacity to handle the demands of both systems.

System 840 may access data sources in systems 820, 830 over the Internet, a secured private LAN, or other communications network. Data sources 811, 812 may include one or more third-party data sources, such as data from banks, credit bureaus, or other relevant sources. For example, data sources 811, 812 may include retailers, credit card processors, or various information services. Data sources 811, 812 may also include data stores and databases local to systems 820, 830, 840.

System 840 may be in communication with machine learning system 850. Machine learning system 850, which may include any parallel or distributed computational framework or cluster 854, may be configured to divide computational jobs into smaller jobs to be performed simultaneously, in a distributed fashion, or both. For example, machine learning system 850 may support data-intensive distributed applications by implementing a map/reduce computational paradigm where the applications may be divided into a plurality of small fragments of work, each of which may be executed or re-executed on any core processor in a cluster of cores. A suitable example of machine learning system 850 includes an Apache Hadoop cluster.

Machine learning system 850 may interface with training data store 880, which also may take the form of a cluster of cores. For example, machine learning system 850 may express a large, distributed computation as a sequence of distributed operations on data sets by dividing the operations into jobs. Such jobs may be executed across a plurality of nodes in the cluster of parallel computational framework 854. The processing and computations described herein may be performed, at least in part, by any type of processor or combination of processors. For example, various types of quantum processors (e.g., solid-state quantum processors and light-based quantum processors), artificial neural networks, and the like may be used to perform massively parallel computing and processing.

Machine learning system 850 may distribute the many tasks across a cluster of nodes and provide the appropriate fragment of intermediate data to each task.

Tasks in each phase may be executed in a fault-tolerant manner, so that if one or more nodes fail during a computation the tasks assigned to such failed nodes may be redistributed across the remaining nodes. This behavior may allow for load balancing and for failed tasks to be re-executed with low runtime overhead.

Data stores 860, 870 and training data store 880 may implement any distributed file system capable of storing large files reliably. For example, they may implement Hadoop's own distributed file system (DFS) or a more scalable column-oriented distributed database, such as HBase, or other data storage and analysis systems such as Google BigQuery, Apache Spark, Snowflake, etc. Such file systems or databases may include BigTable-like capabilities, such as support for an arbitrary number of table columns.

It can be further understood that while a brief overview of exemplary systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used, or modifications and additions can be made to the described embodiments for performing the same or equivalent function of the corresponding embodiments without deviating therefrom.

One of ordinary skill in the art can appreciate that the various embodiments of the disclosed subject matter and related systems, devices, and/or methods described herein can be implemented in connection with various computer or other client or server device, which can be deployed as part of a communications system, a computer network, and/or in a distributed computing environment, and can be connected to any kind of data store. In this regard, the various embodiments described herein can be implemented in several types of computer system or environment having any number of memory or storage units, and many applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

Those skilled in the art will recognize that it is common within the art to describe devices and/or processes in the fashion set forth herein, and thereafter use engineering practices to integrate such described devices and/or processes into systems. That is, at least a portion of the devices and/or processes described herein can be integrated into a system via a reasonable amount of experimentation. Those having skill in the art will recognize that a typical system can include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control device (e.g., feedback for sensing position and/or velocity; control devices for moving and/or adjusting parameters). A typical system can be implemented utilizing any suitable commercially available components, such as those typically found in data computing/communication and/or network computing/communication systems.

Various embodiments of the disclosed subject matter sometimes illustrate different components contained within, or connected with, other components. It is to be understood that such depicted architectures are merely exemplary, and that, in fact, many other architectures can be implemented which achieve the same and/or equivalent functionality. In a conceptual sense, any arrangement of components to achieve the same and/or equivalent functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” “operably coupled,” “communicatively connected,” and/or “communicatively coupled,” to each other to achieve the desired functionality, and any two components capable of being so associated can also be viewed as being “operably couplable” or “communicatively couplable” to each other to achieve the desired functionality. Specific examples of operably couplable or communicatively couplable can include, but are not limited to, physically mateable and/or physically interacting components, wirelessly interactable and/or wirelessly interacting components, and/or logically interacting and/or logically interactable components.

With respect to substantially any plural and/or singular terms used herein, those having skill in the art can translate from the plural to the singular and/or from the singular to the plural as can be appropriate to the context and/or application. The various singular/plural permutations may be expressly set forth herein for the sake of clarity, without limitation.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those skilled in the art that, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limit any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those skilled in the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

In addition, the words “exemplary” and “non-limiting” are used herein to mean serving as an example, instance, or illustration. For the avoidance of doubt, the subject matter disclosed herein is not limited by such examples. Moreover, any aspect or design described herein as “an example,” “an illustration,” “exemplary” and/or “non-limiting” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements, as described above.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a computer and the computer can be a component. In addition, one or more components can reside within a process and/or thread of execution and a component can be localized on one computer and/or distributed between two or more computers.

Systems described herein can be described with respect to interaction between several components. It can be understood that such systems and components can include those components or specified sub-components, some of the specified components or sub-components, or portions thereof, and/or additional components, and various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle component layers, such as a management layer, can be provided to communicatively couple to such sub-components in order to provide integrated functionality, as mentioned. Any components described herein can also interact with one or more other components not specifically described herein but generally known by those of skill in the art.

As mentioned, in view of the exemplary systems described herein, methods that can be implemented in accordance with the described subject matter can be better appreciated with reference to the flowcharts of the various figures and vice versa. While for purposes of simplicity of explanation, the methods can be shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks can be required to implement the methods described hereinafter.

While the disclosed subject matter has been described in connection with the disclosed embodiments and the various figures, it is to be understood that other similar embodiments may be used, or modifications and additions may be made to the described embodiments for performing the same function of the disclosed subject matter without deviating therefrom. Furthermore, multiple processing chips or multiple devices can share the performance of one or more functions described herein, and similarly, storage can be affected across a plurality of devices. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methods, as shown and described herein. In any event, the systems, structures and/or devices, as well as the associated methods described herein have many applications in various aspects of the disclosed subject matter, and so on. Accordingly, the invention should not be limited to any single embodiment, but rather should be construed in breadth, spirit and scope in accordance with the appended claims.

What is claimed is:

1. An intelligent clearinghouse system comprising:
a first datastore on a first server storing data including decisioning rules of each of a plurality of service providers for responding to one or more requests for decisions from individuals;
a second datastore on the first server storing data including system connection information for each of the plurality of service providers;
a computer network connection for receiving, at a first time, an inquiry from an individual, wherein the inquiry contains:
a request for a decision, and
a first relevant data set including the individual's identity;
a memory comprising computer executable instructions for requesting and obtaining, from a remote datastore, a second relevant data set based on transmission of the individual's identity to a remote server;
a parallel processing system for applying, using a machine learning algorithm, the first relevant data set, the second relevant data set, and the request for decision to the decisioning rules to reach at least one response to the inquiry; and
wherein the memory further comprises computer executable instructions for sending, at a second time, to the individual, via computer network, an indication of the at least one response to the inquiry, wherein the indication of the at least one response indicates a decision regarding a first service provider.

2. The system of claim 1, wherein the memory further comprises computer executable instructions for:
providing to the individual, via computer network, a connection to the first service provider's computer system; and
providing to the first service provider, via computer network, an indication of the decision regarding the first service provider.

3. The system of claim 1, wherein the computer executable instructions require that the second time is less than five minutes after the first time.

4. The system of claim 1, wherein the memory further comprises computer executable instructions for:
after reaching the at least one response to the inquiry, applying, using a machine learning algorithm, the first relevant data set, the second relevant data set, and the request for decision to the decisioning rules to reach a plurality of additional responses to the inquiry; and
sending, within 10 seconds of the second time, to the individual, via computer network, a plurality of indications of the plurality of additional responses to the inquiry, wherein the plurality of indications indicate a plurality of decisions.

5. The system of claim 1, wherein the inquiry containing a request for decision indicates at least one request compatibility criterion and a desired amount of available resources.

6. The system of claim 5, wherein at least one of the plurality of service providers'decisioning rules includes at least one rule regarding the amount of available resources that can be committed within at least one specified restriction criterion.

7. The system of claim 1, wherein the memory further comprises computer executable instructions for:
seeking and obtaining consent from an individual prior to applying the individual's request for decision to the decisioning rules, and
determining a more optimal set of service providers related to the obtaining consent before executing the instructions for seeking consent.

8. An intelligent clearinghouse method comprising:
obtaining, from a plurality of service providers, each of the plurality of service providers'decisioning rules for responding to one or more requests for decisions from individuals;
obtaining, from the plurality of service providers, each service provider's system connection information;
storing the obtained decisioning rules and system connection information;
receiving, via computer network connection at a first time, an inquiry from an individual, wherein the inquiry contains:
a request for a decision, and
a first relevant data set including the individual's identity;
requesting and obtaining, from a remote datastore, a second relevant data set based on transmission of the individual's identity to a remote server;
applying, using a machine learning algorithm, the first relevant data set, the second relevant data set, and the request for decision to the decisioning rules to reach at least one response to the inquiry; and
sending, at a second time, to the individual, via computer network, an indication of the at least one response to the inquiry, wherein the indication of the at least one response indicates a decision regarding a first service provider.

9. The method of claim 8, further comprising
providing to the individual, via computer network, a connection to the first service provider's computer system; and
providing to the first service provider, via computer network, an indication of the decision regarding the first service provider.

10. The method of claim 8, wherein the second time is less than five minutes after the first time.

11. The method of claim 8, further comprising:
after reaching the at least one response to the inquiry, applying, using a machine learning algorithm, the first relevant data set, the second relevant data set, and the request for decision to the decisioning rules to reach a plurality of additional responses to the inquiry; and
sending, within 10 seconds of the second time, to the individual, via computer network, a plurality of indications of the plurality of additional responses to the inquiry, wherein the plurality of indications indicate a plurality of decisions.

12. The method of claim 8, wherein the inquiry containing a request for decision indicates a at least one request compatibility criterion and a desired amount of available resources.

13. The method of claim 12, wherein at least one of the plurality of service providers'decisioning rules includes at least one rule regarding the amount of available resources that can be committed within at least one specified restriction criterion.

14. The method of claim 8, further comprising:
seeking and obtaining consent from the individual prior to applying the individual's request for decision to the decisioning rules, and
determining a more optimal set of service providers related to the obtaining consent before executing the instructions for seeking consent.

15. A non-transitory computer-readable storage medium comprising:
instructions that, when executed by a device comprising processor, facilitate performance of intelligent clearinghouse operations comprising:
obtaining, from a plurality of service providers, each of the plurality of service providers'decisioning rules for responding to one or more requests for decisions from individuals;
obtaining, from the plurality of service providers, each service provider's system connection information;
storing the obtained decisioning rules and system connection information;
receiving, via computer network connection at a first time, an inquiry from an individual, wherein the inquiry contains:
a request for a decision, and
a first relevant data set including the individual's identity;
requesting and obtaining, from a remote datastore, a second relevant data set based on transmission of the individual's identity to a remote server;
applying, using a machine learning algorithm, the first relevant data set, the second relevant data set, and the request for decision to the decisioning rules to reach at least one response to the inquiry; and
sending, at a second time, to the individual, via computer network, an indication of the at least one response to the inquiry, wherein the indication of the at least one response indicates a decision regarding a first service provider.

16. The medium of claim 15, further comprising instructions that, when executed by a device comprising processor, facilitate performance of operations comprising:
providing to the individual, via computer network, a connection to the first service provider's computer system; and
providing to the first service provider, via computer network, an indication of the decision regarding the first service provider.

17. The medium of claim 15, wherein the second time is less than five minutes after the first time.

18. The medium of claim 15, further comprising instructions that, when executed by a device comprising a processor, facilitate performance of operations comprising:
after reaching the at least one response to the inquiry, applying, using a machine learning algorithm, the first relevant data set, the second relevant data set, and the request for decision to the decisioning rules to reach a plurality of additional responses to the inquiry; and
sending, within 10 seconds of the second time, to the individual, via computer network, a plurality of indications of the plurality of additional responses to the inquiry, wherein the plurality of indications indicate a plurality of decisions.

19. The medium of claim 15, wherein the inquiry containing a request for decision indicates at least one request compatibility criterion and a desired amount of available resources.

20. The medium of claim 19, wherein at least one of the plurality of service providers'decisioning rules includes at least one rule regarding the amount of available resources that can be committed within at least one specified restriction criterion.
